(19) United States
(12) Patent Application Publication
(10) Pub. No.: US 2012/0136908 A1
(43) Pub. Date: May 31, 2012

(54) VIRTUAL ATTRIBUTE BASED ACCESS CONTROL

(75) Inventors: Richard V. Hom, Troy, MI (US); Eric M. Nelson, Durham, NC (US); David C. Roxin, Baltimore, MD (US)

(73) Assignee: INTERNATIONAL BUSINESS MACHINES CORPORATION, Armonk, NY (US)

(21) Appl. No.: 12/955,087

(22) Filed: Nov. 29, 2010

(51) Int. Cl. G06F 17/30

(52) U.S. Cl. 707/831; 707/E17.01

(57) ABSTRACT

The present invention involves creating an attribute in a directory and having a system provide attribute values for data that changes rapidly with a speed high enough to satisfy real-time requirements. The present invention calculates values rather than storing them for each attribute of an object class instance. It provides “virtual attributes” and using them in Attribute Based Access Control (ABAC). The resulting Virtual Attribute Based Access Control (VABAC) system allows a Policy Decision Point (PDP) to make better informed decisions based on information that results from metrics, statistics, or data from some outside system. Given virtual attributes, the PDPs can make access decisions based on things like reputation, skill level, trust level, organizational structure, etc.

### FIELD OF THE INVENTION

One aspect of the present invention provides for a method and a system for efficiently providing directory clients with information that cannot be stored in a directory server and for adding “virtual attributes” to a directory.

There is a need to provide for a new virtual attribute based access method and system.

### BACKGROUND OF THE INVENTION

In a rapidly changing environment, the decision as to whether or not a subject may access a controlled resource must be made based on information that does not exists as attributes in directory. For example, when a subject becomes a security risk, enterprises need to immediately suspend access of the suspected subject to controlled resources. These resources may be physical (e.g., buildings, vehicles, machinery, weapons) or virtual (e.g., web services, applications).

A person may become a security risk for any number of reasons that may be assessed through calculation of some value that does not exist as an attribute in a directory.

What is needed is a system and method for providing “virtual attributes” and using them in Attribute Based Access Control (ABAC). The resulting Virtual Attribute Based Access Control (VABAC) system allows a Policy Decision Point (PDP) to make better informed decisions based on information that results from metrics, statistics, or data from some outside system and for efficiently providing directory clients with information that cannot be stored in a directory server and for adding “virtual attributes” to a directory.

Therefore, there exists a need for a solution that solves at least one of the deficiencies of the related art.

### SUMMARY OF THE INVENTION

The present invention may comprise a system and method for providing “virtual attributes” and using them in Attribute Based Access Control (ABAC). The resulting Virtual Attribute Based Access Control (VABAC) system allows a Policy Decision Point (PDP) to make better informed decisions based on information that results from metrics, statistics, or data from some outside system. Given virtual attributes, the PDPs can make access decisions based on things like reputation, skill level, trust level, organizational structure, etc.

The present invention adds “virtual attributes” to a directory. A virtual attribute is an element of a directory object that, from a directory client's perspective, looks and behaves like a directory attribute. Unlike a real directory attribute, the value of an ObjectClass instance's virtual attribute would be calculated via some computation instead of being retrieved from some database or attribute store. The information source of the computation may come from external systems, internal “real” attributes, or a combination of both.

A good example of a virtual attribute would be the current location of a satellite. The directory would associate the satellite's orbital trajectory formula with the location attribute of a satellite, but would never store the value of the current location of the satellite since it is always moving. If a directory client requested the value for the location of a satellite, the directory would return the coordinates, but calculate them on the fly instead of retrieving them from a database.

The present invention may provide a system for efficiently providing directory clients with information that cannot be stored in a directory server and for adding virtual attributes to a directory comprising a virtual attribute input unit, a virtual attribute based access control unit, a processing unit and a virtual attributes database.

The present invention may further comprise a method for efficiently providing directory clients with information that cannot be stored in a directory server and for adding “virtual attributes” to a directory, the method comprising creating an attribute in a directory and refreshing the system with data with a frequency that is high enough to satisfy real-time requirements.

The present invention may further comprise a computer-readable medium storing computer instructions, which, when executed, enables a system operating for efficiently providing directory clients with information that cannot be stored in a directory server and for adding “virtual attributes” to a directory, to perform steps comprising creating an attribute in a directory and refreshing the system with data with a frequency that is high enough to satisfy real-time requirements.

The present invention a method for deploying a system for efficiently providing directory clients with information that cannot be stored in a directory server and for adding “virtual attributes” to a directory, the method comprising creating an attribute in a directory and refreshing the system with data with a frequency that is high enough to satisfy real-time requirements.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a VABAC that works by a subject providing an access resource request (for a controlled resource) to a Policy Enforcement Point (PEP) which gets access approval from a Policy Decision Point (PDP) which bases its decision on the value of an attribute of a directory even though that value does not exist in that directory.

FIG. 2 illustrates a Data Processing System suitable for storing and/or executing program code of the present invention may include System having at least one processor and Virtual Attribute Based Access Control Unit connected to Virtual Attribute Input Unit connected to System, coupled directly or indirectly to Memory through System Bus.

FIG. 3 shows a structure having a directory user (which could be a VABAC) communicating with a VAED. FIG. 3 also shows an example of a VAED working with three different Data Sources and the Calculation Methods used to access those Data Sources.

FIG. 4 illustrates an example of Calculation Methods and how they must all provide a common interface to work within a VAED.

FIG. 5 illustrates a system how the attribute store would work.

The drawings are merely schematic representations, not intended to portray specific parameters of the invention. The drawings are intended to depict only typical embodiments of the invention, and therefore should not be considered as limiting the scope of the invention.

### DETAILED DESCRIPTION OF THE DRAWINGS

Security risk may be assessed based on using a combination of a rule based system in conjunction with some calculation that may include metrics and statistical analysis. Rules that specify minimum/maximum/equivalent metrics for given contexts will provide or deny access to resources. The result of these calculations become virtual attributes in an Attribute Based Access Control (ABAC) system. The solution of the present invention has the advantage of instantaneous and very dynamic assessment without the decision making of a superior.

This invention adds “virtual attributes” to a directory. A virtual attribute is an element of a directory object that, from a directory client's perspective, looks and behaves like a directory attribute. Unlike a real directory attribute, the value of an ObjectClass instance's virtual attribute would be calculated via some computation instead of being retrieved from some database or attribute store. The information source of the computation may come from external systems, internal “real” attributes, or a combination of both.

A good example of a virtual attribute would be the current location of a satellite. The directory would associate the satellite's orbital trajectory formula with the location attribute of a satellite, but would never store the value of the current location of the satellite since it is always moving. If a directory client requested the value for the location of a satellite, the directory would return the coordinates, but calculate them on the fly instead of retrieving them from a database. Another example of virtual attributes include acquisition of instrumentation data from monitoring devices.

The current solution requires a superior to evaluate each person and to deny access based on a personal decision. This control does not happen in real time, is based on the superior's biases, and requires the superior to have access to a control system. In Attribute-Based Access Control (ABAC), a Policy Decision Point (PDP) may require one or more attributes which do not exist in a directory. As a result, the PDP must make a decision based solely on the attributes that are available. The PDP, in this case, cannot make an informed decision and results in a sub-optimal decision.

A mechanism is needed to efficiently provide directory clients with information that cannot be stored in a directory server. The dynamic nature of some information makes it impossible to store anywhere. Some information quickly becomes obsolete or loses value (e.g., real-time data acquisition systems), making placement in a directory problematic. Although, this information does not reside on directory sources, it is advantageous to provide access to it through an instance of a directory object class for the sake of directory clients. This information may be used by Virtual Attribute Based Access Control (VABAC) systems to control access to resources (e.g., data and applications).

The VABAC works by providing a value for a directory attribute even though that value does not exist in that directory. A virtual directory that adheres to the directory interface calculates the value as it is needed. This virtual directory may cache the value for short periods of time to reduce processing time.

The virtual directory may be implemented as a wrapper around another directory and intercepts the directory request. It parses the request, calculating the virtual attributes itself and passing the normal attribute request to the wrapped directory.

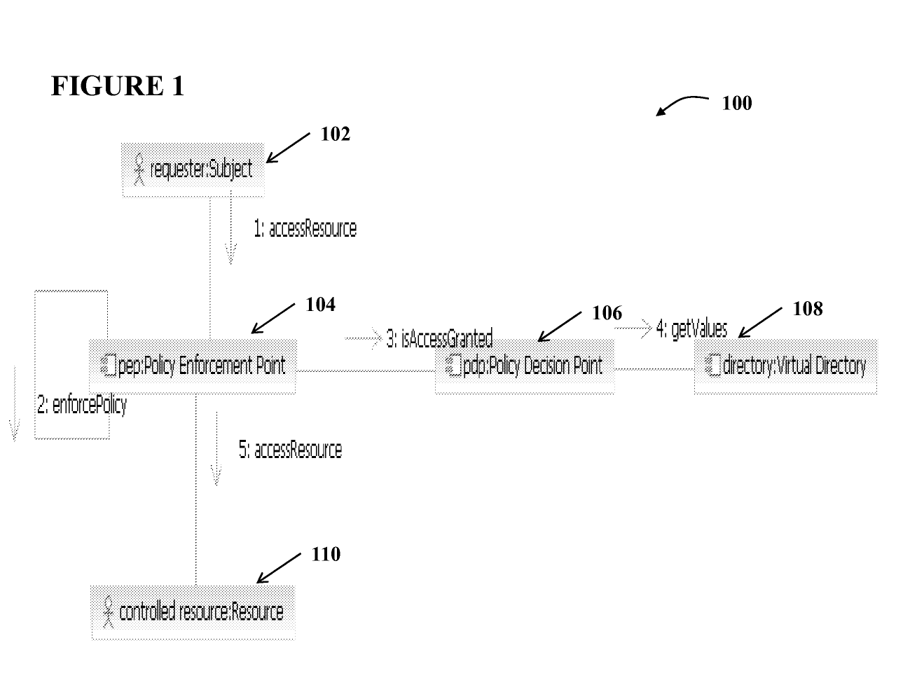

When someone attempts to access a controlled resource, a Policy Enforcement Point (PEP) requests an access decision from a PDP. That PDP then bases a decision based on policies and the virtual attributes retrieved from the virtual directory. At that point the virtual directory computes the value for the virtual attributes and returns it as though it were a real attribute. Like any ABAC, the VABAC requires an authentication system (biometric, challenge/response, etc.) to identify the subject. Once the identity is confirmed, the subject attempts to access the resource under control (FIG. 1, Step 1). To provide access, the PEP must enforce the policies regarding access (FIG. 1, Step 2) requiring a decision from the PDP (FIG. 1, Step 3). The system may use predetermined associations between the resource and some virtual attributes (probably in the form of a policy). The system then interfaces with a virtual directory to calculate the values of the virtual attributes (FIG. 1, Step 4). If the subject satisfies the predetermined policy for the virtual attribute(s) in those contexts for that resource, the subject is allowed access to the resource (FIG. 1, Step 5).

In FIG. 1, the VABAC 100 works by a subject 102 providing an accessResource request (for a controlled resource) to a Policy Enforcement Point (PEP) 104 which gets access approval from a Policy Decision Point (PDP) which bases its decision on the value of an attribute of a directory even though that value does not exist in that directory. A Virtual Attribute Enabled Directory 108 that adheres to the directory interface calculates the value as it is needed. This Virtual Attribute Enabled Directory 108 may cache the value for short periods of time to reduce processing time. Virtual Directory 108 may be implemented as a wrapper around another directory and intercepts the directory request. It parses the request, calculating the virtual attributes itself and passing the normal attribute request to the wrapped directory.

When someone (Subject 102) attempts to access Controlled Resource 110, Policy Enforcement Point (PEP) 104 requests an access resource decision from a PDP 106. PDP 106 then bases a decision based on policies and the virtual attributes retrieved from Virtual Attribute Enabled Directory or Virtual Directory 108. At that point, Virtual Directory 108 computes the value for the virtual attributes and returns it as though it were a real attribute. Like any ABAC, the VABAC 100 requires an authentication system (biometric, challenge/response, etc.) to identify the subject. Once the identity is confirmed, Subject 102 attempts to access Resource under control 110 (FIG. 1, Step 1). To provide access, the PEP 104 must enforce the policies regarding access (FIG. 1, Step 2) requiring a decision from the PDP (FIG. 1 Step 3). The system uses predetermined associations between Resource 110 and some virtual attributes (in the form of a policy). System 100 then interfaces with Virtual Directory 108 to calculate the values of the virtual attributes (FIG. 1, Step 4). If Subject 102 satisfies the predetermined policy for the virtual attribute(s) in those contexts for that resource, Subject 102 is allowed access to Resource 110 (FIG. 1, Step 5).

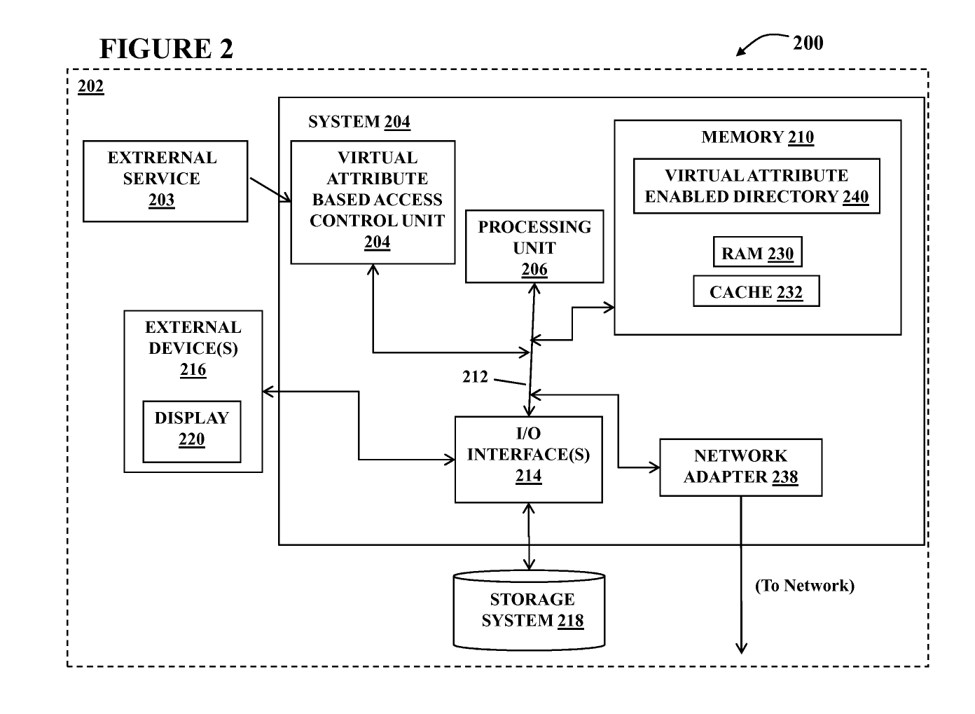

FIG. 2 illustrates System 200 including a system such as Data Processing System 202 shown in FIG. 2, suitable for storing and/or executing program code of the present invention may include System 204 having at least one processor (Processing Unit 206) and Virtual Attribute Based Access Control Unit 204 connected to External Service with controlled resources 203 connected to System 204, coupled directly or indirectly to Memory 210 through System Bus 212. Virtual Attribute Based Access Control Unit 204 more likely be on a different machine but it is shown in the same Data Processing System 202 for clarity. Memory 210 may include local memory (RAM 230) employed during actual execution of the program code and cache memories (Cache 232) that provide temporary storage of at least some program code in order to reduce the number of times code must be retrieved from Bulk Storage 218, connected to Virtual Attributes Database 240, during execution.

Input/output or I/O devices (External Peripherals 216) (including but not limited to keyboards, displays (Display 220), pointing devices, etc.) can be coupled to System 204 (FIG. 2), either directly or indirectly through a network (FIG. 2) through intervening I/O controllers (I/O interface(s) 214).

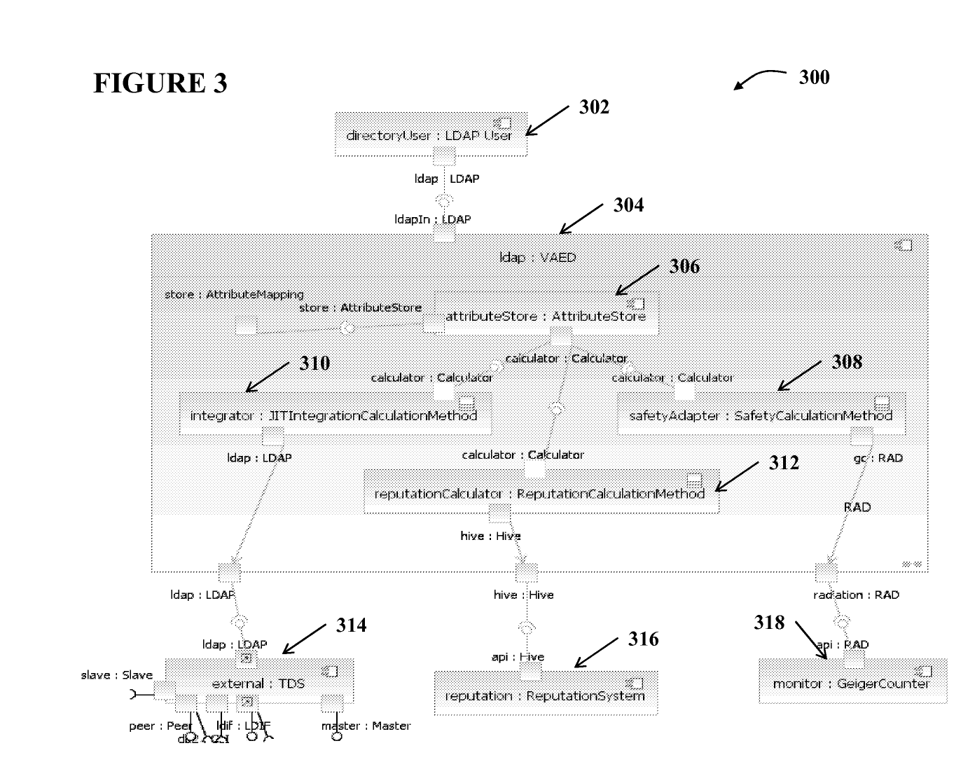

FIG. 3 shows Structure 300 having a directory user (e.g., PDP) 302 communicating with VAED 304 having Attribute Store 306 connected to examples of Value Calculation Method (Safety Calculation method 308, Integration Calculation Method 310 and Reputation Calculation Method 312). Integration Calculation Method 310 is further connected to TDS 314 while Reputation Calculation Method 312 is connected to Reputation System 316 and Safety Calculation method 308 is connected to Geiger Counter 318, as an example.

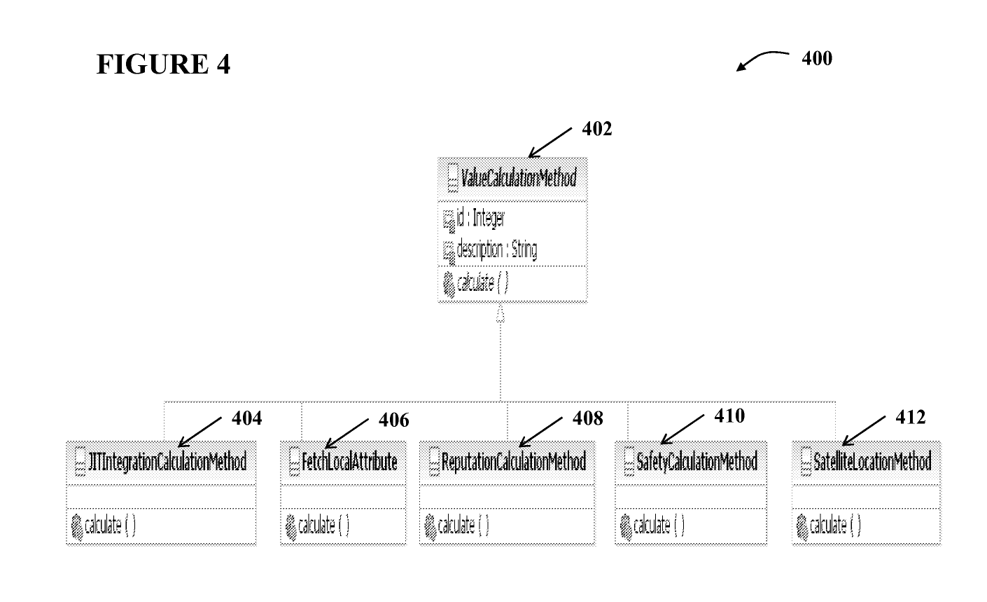

FIG. 4 illustrates an example of Value Calculation Methods and how they must all provide a common interface to work within a VAED. These examples are not all inclusive and are meant to provide an understanding of the variety of Value Calculation Methods that might be created.

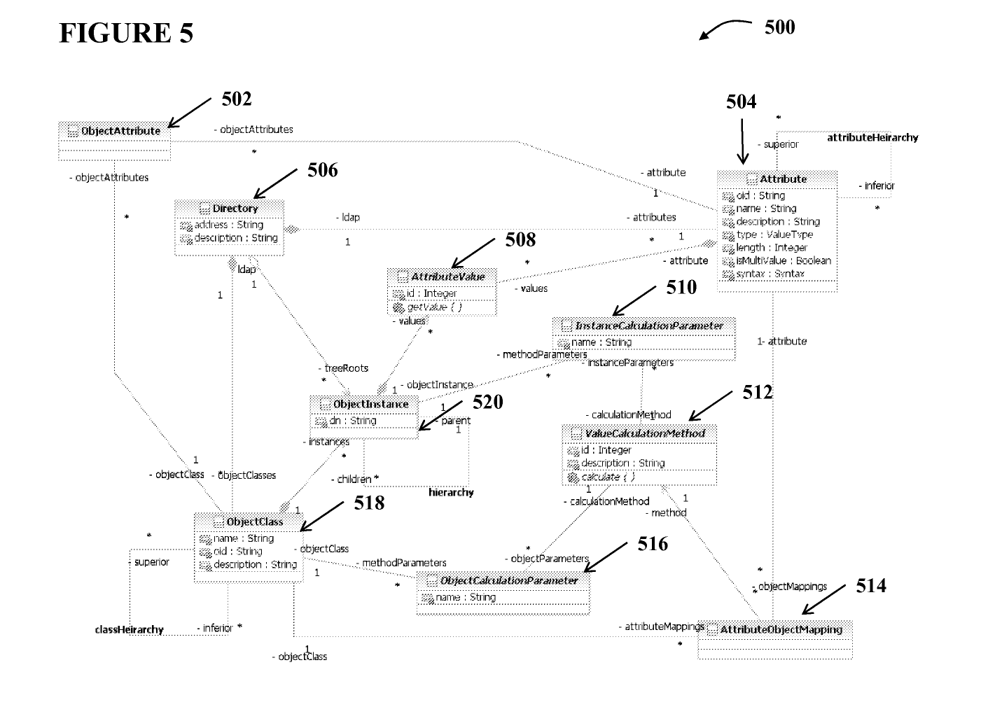

FIG. 5 illustrates a Structure 500 having Object Attribute 502 connected to Attribute 504. It also has Directory 506, Attribute Value 508, Instance Calculation Parameter 510, Value Calculation Method 512, Attribute Object Mapping 514, Object Calculation Parameter 516, Object Class 518, and Object Instance 520.

FIG. 5 shows System 500 how the Attribute Store would work. The Attribute Store 500 would work much as other directories, except that the mapping between the Object Class 518 and Attribute 504 would provide a link to a ValueCalculationMethod 512 (which is a Strategy for calculating the value). ValueCalculationMethod 512 determines how the value should be calculated for the attribute of an object instance 520. ValueCalculationMethod 512 has both instanceParameters (InstanceCalculationParameter) 510 and objectParameters (ObjectCalculationParameter) 516 that it uses to calculate the value of a virtual attribute. The instanceParameters contain information for a particular instance (e.g., orbital trajectory of a satellite). The objectParameters contain information that is common to the entire class of objects (e.g., gravitational force constant of the Earth). Both types of parameters are used only for the calculation methods. They are not query-able directory attributes.

It should be understood that the present invention is typically computer-implemented via hardware and/or software. As such, client systems and/or servers will include computerized components as known in the art. Such components typically include (among others) a processing unit, a memory, a bus, input/output (I/O) interfaces, external devices, etc.

While shown and described herein as a system and method for efficiently providing directory clients with information that cannot be stored in a directory server and for adding “virtual attributes” to a directory. For example, in one embodiment, the invention provides a computer-readable/useable efficiently providing directory clients with information that cannot be stored in a directory server and for adding “virtual attributes” to a directory. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a computer-implemented method for efficiently providing directory clients with information that cannot be stored in a directory server and for adding “virtual attributes” to a directory. In this case, a computerized infrastructure can be provided and one or more systems for performing the process steps of the invention can be obtained (e.g., created, purchased, used, modified, etc.) and deployed to the computerized infrastructure. To this extent, the deployment of a system can comprise one or more of (1) installing program code on a computing device, such as computer system from a computer-readable medium; (2) adding one or more computing devices to the computer infrastructure; and (3) incorporating and/or modifying one or more existing systems of the computer infrastructure to enable the computerized infrastructure to perform the process steps of the invention.

As used herein, it is understood that the terms “program code” and “computer program code” are synonymous and may mean any expression, in any language, code or notation, of a set of instructions intended to cause a computing device having an information processing capability to perform a particular function either directly before or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

In another embodiment, the invention provides a business method that performs the process steps of the invention on a subscription, advertising, and/or fee basis. That is, a service provider, such as a solution integrator, could offer to deploy a computer infrastructure for efficiently providing directory clients with information that cannot be stored in a directory server and for adding “virtual attributes” to a directory. In this case, the service provider can create, maintain, and support, etc., the computer infrastructure by integrating computer-readable code into a computing system, wherein the code in combination with the computing system is capable of performing the process steps of the invention for one or more customers. In return, the service provider can receive payment from the customer(s) under a subscription and/or fee agreement and/or the service provider can receive payment from the sale of advertising content to one or more third parties.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A system for efficiently providing directory clients with information that cannot be stored in a directory server and for adding virtual attributes to a directory comprising:
a virtual attribute based access control unit;
a processing unit; and
a virtual attributes database.

2. The system as defined in claim 1 further comprising a virtual directory and a policy decision point.

3. The system as defined in claim 2 further comprising a policy enforcement point.

4. The system as defined in claim 3 further comprising a view element for a directory user.

5. The system as defined in claim 4 further comprising a VAED having an attribute store.

6. The system as defined in claim 5 further comprising a value calculation method element (e.g., a safety calculation method element and a reputation calculation element).

7. A method for efficiently providing directory clients with information that cannot be stored in a directory server and for adding “virtual attributes” to a directory, the method comprising:
creating an attribute in a directory;
calculating attribute values instead of storing them for rapidly changing data with a frequency that is high enough to satisfy real-time requirements.

8. The method as defined in claim 7 further comprising determining if the information becomes stale quickly and, if so, updating the attribute just in time (in the case of cached data).

9. The method as defined in claim 8 further comprising reducing processing time and bandwidth requirements.

10. A computer-readable medium storing computer instructions, which, when executed, enables a system operating for efficiently providing directory clients with information that cannot be stored in a directory server and for adding “virtual attributes” to a directory, to perform steps comprising:
creating an attribute in a directory;
calculating attribute values instead of storing them for rapidly changing data with a speed that is high enough to satisfy real-time requirements.

11. The computer-readable medium as defined in claim 10 further comprising determining if the information becomes stale quickly and, if so, updating the attribute just in time (in the case of cached data).

12. The computer-readable medium as defined in claim 11 further comprising reducing processing time and bandwidth requirements.

13. A method for deploying a system for efficiently providing directory clients with information that cannot be stored in a directory server and for adding “virtual attributes” to a directory, the method comprising:
creating an attribute in a directory; and
calculating attribute values instead of storing them for rapidly changing data with a speed that is high enough to satisfy real-time requirements.

14. The method as defined in claim 13 further comprising determining if the information becomes stale quickly and, if so, updating the attribute just in time (in the case of cached data).

15. The method as defined in claim 14 further comprising reducing processing time and bandwidth requirements.
